(19) United States
(12) Patent Application Publication
(10) Pub. No.: US 2003/0039176 A1
(43) Pub. Date: Feb. 27, 2003

(54) Tandem compact disc player

(76) Inventor: Fred DePoalo, New Milford, NJ (US)

Correspondence Address: Richard W. Goldstein, 2071 Clove Road, Staten Island, NY, 10304, US

(21) Appl. No.: 09/773,717

(22) Filed: Feb. 1, 2001

(51) Int. Cl. G11B 7/085

(52) U.S. Cl. 369/4; 369/30.2

(57) ABSTRACT

A tandem CD player for playing a selected track from two different CDs is disclosed. The tandem CD player comprises a control unit, a control panel that is connected to said control unit, and two CD players. The control panel has a plurality of controls for adjusting the control unit, including a fader control for adjusting a time period between songs played on alternating CD players. The control unit is connected to the two CD players for controlling their operations. The tandem CD player may also comprise a mixer unit that controls the sound output from the tandem CD player.

### CROSS REFERENCES AND RELATED SUBJECT MATTER

This application relates to subject matter present in patent application Ser. No. 09/175,377, filed in the United States Patent Office on Oct. 19, 1998.

### BACKGROUND OF THE INVENTION

This invention relates to a compact disc (CD) player. More particularly, this invention relates to a CD player that allows the user to hear selected tracks from two different discs without any interruption.

For those who grew up in the 50s and 60s, single song play on a record player was the standard. The user was able to play one track after another on a manual turntable or on an automatic changer. The automatic changer allowed the user the benefit of being able to play one favorite single after another from different records, without interruption.

In modern times, CDs have become more popular because of their superior sound quality as opposed to the sound quality of records. A user may use a single drawer CD player that allows the user to hear one CD at a time. A single drawer CD player has the disadvantage that one is unable to quickly switch between two tracks on separate CDs. Instead, the user must open the CD drawer, remove the disc already in it, close the drawer, program the next track to be played, and then wait as the player cues up the track and begins to play.

U.S. Pat. No. 5,577,010 to Haque discloses an apparatus for selectively retrieving and playing a plurality of CDs. The Haque Patent discloses an apparatus for retrieving an awaiting CD from the loading station, and placing the retrieved CD onto the attached CD player, and for returning the CD from the player to the loading station. However, the user is forced to wait while the player switches CDs back and forth from the loading station.

Alternately, one may use a carousel-type CD player that allows the user to hear a plurality of CDs without having to load and unload after playing each CD. The carousel player allows the user to place a plurality of CDs in the tray and program as many tracks as desired. However, the user is still forced to wait while the player cues up to the next track to be played.

Thus, existing CD players are not helpful to those who desire to hear a particular track from one CD and then a track on another CD without interruption. Consequently, for those who are in the business of mixing music, such as disc jockeys or the like, it is necessary to utilize two different CD players to obtain uninterrupted music from a variety of different CDs.

The user may connect the two CD players to an amplifier having two distinct input channels. The use of two distinct CD players also requires the user to constantly switch the input selector on the amplifier back and forth when switching between tracks on different CDs.

Often, a disc jockey mixing two distinct tracks wishes to “fade out” the first track before the next track starts to play. However, the use of two distinct CD players with an amplifier makes it impossible to obtain the fading feature, unless the two CD players are first connected to a soundboard or a sound mixer which is then connected to the amplifier. However, the use of a sound mixer results in additional expenses and requires the user to constantly manipulate knobs or slide bars.

Accordingly, there is a need for an apparatus that allows the user to play one track from one CD and then switch to another track from another CD without any interruption or loss of signal strength. There is also a need for an apparatus that incorporates a control mechanism to obtain fading between different tracks.

### SUMMARY OF THE INVENTION

An object of the present invention is to provide an apparatus that allows the user to play one track from a CD, and upon completion of the first track switch to another track from another CD without any interruption. Accordingly, a tandem CD player is provided that allows the user to hear a track from a CD, while being able to program a track on a second CD.

Another object of the present invention is to provide a fading mechanism that allows the user to set a fading period that fades out a track before it starts playing the second track.

To accomplish these and other related objects, the present invention may be embodied in the forms illustrated in the enclosed drawings. It is to be noted that the scope of the present invention is not limited by this description or the enclosed drawings, and may include other embodiments known or obvious to those skilled in the art of the present invention.

### BRIEF DESCRIPTION OF THE DRAWINGS

For a better understanding of the above and other features of the present invention, reference should be made to the following detailed description of the preferred embodiments illustrated in the accompanying drawings, wherein:

FIG. 1 is a front perspective view of the present invention.

FIG. 2 is a block diagram of the present invention.

### DETAILED DESCRIPTION OF THE PREFERRED EMBODIMENTS

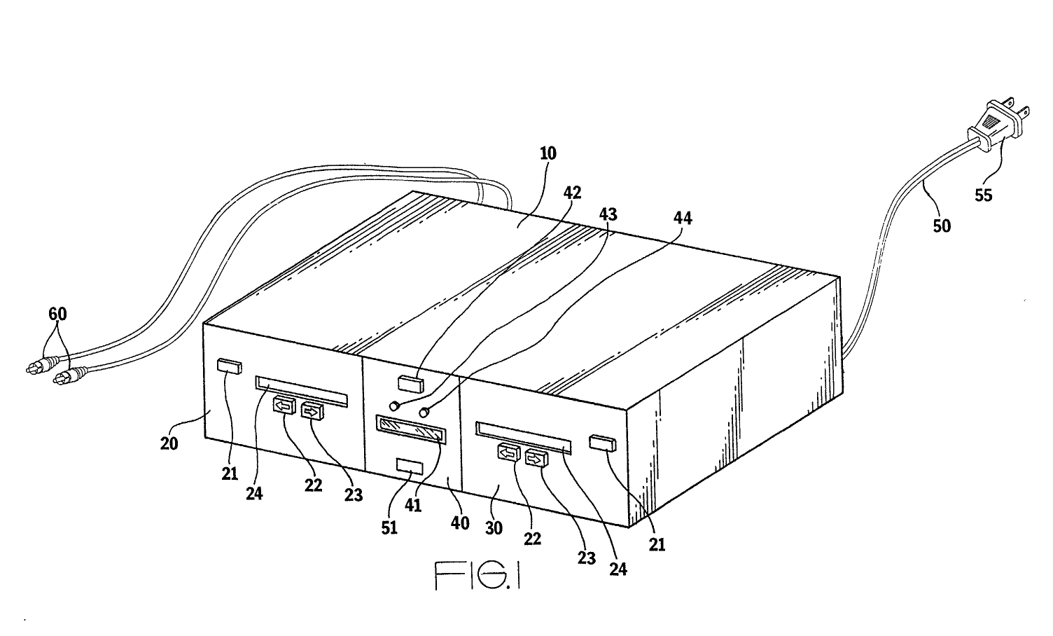

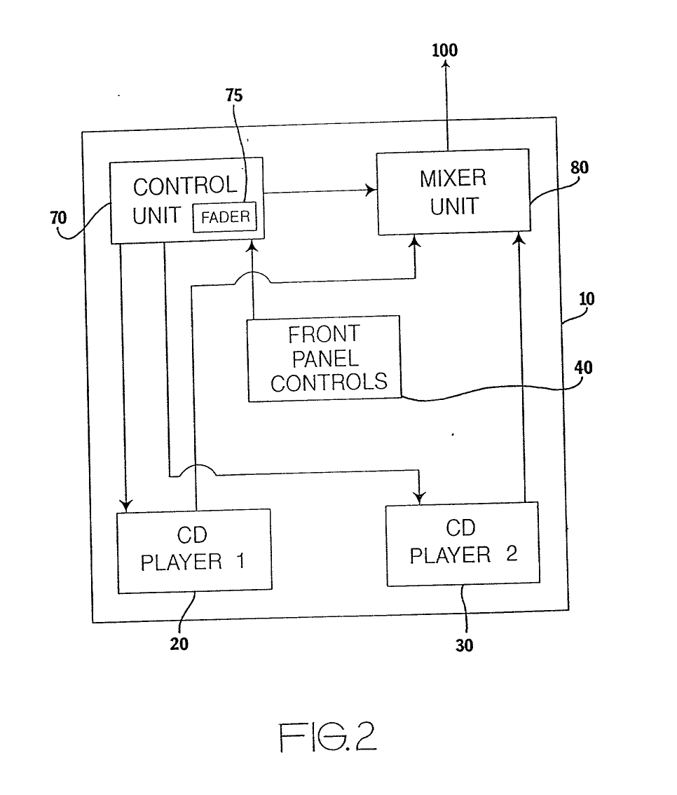

FIGS. 1 and 2 refer to a tandem CD player 10. The tandem CD player 10 allows the user to play one track from one CD, and upon completion of the first track switch to another track from another CD without any interruption. The tandem CD player 10 is comprised of a control panel 40, a control unit 70, a mixer unit 80, a first CD player 20 and a second CD player 30.

As shown in FIG. 1, the first CD player 20 and the second CD player 30 are each provided with a CD drawer 24, an open/close control button 21, a backward search button 22 and a forward search button 23.

When the open/close control button 21 is pressed by the user, the CD drawer 24 opens or closes accordingly. Once a CD has been placed in the CD drawer 24, the CD drawer 24 is closed by pressing the open/close control button 21.

Once a CD has been loaded onto the CD drawer 24, the user may cue the CD to the desired track by pressing the backward search button 22 or the forward search button 23. The CD moves up one track each time the forward search button 23 is pressed. On the other hand, the CD moves back one track each time the backward search button 22 is pressed. Once the user has cued the CD to the desired track, he stops pressing the backward search button 22 or the forward search button 23, and the tandem CD player 10 is automatically programmed to play the selected track. Similarly, the user cues and programs the CD loaded in the other CD player.

Once the selected track from the first CD player 20 or the second CD player 30 has been played, the tandem CD player 10 automatically jumps to the track selected on the second CD player.

Both the first CD player 20 and the second CD player 30 are connected to the control unit 70. The control unit may be comprised of a number of different controls, including a fading unit 75.

As shown in FIG. 2, the control panel 40 is connected to the control unit 70. When any of the controls on the controls panel 40 are altered by the users, the control unit 70 adjusts the two CD players 20,30 accordingly. The controls panel 40 comprises a power button 42, a transfer button 43, a fader button 44 and a display 41. According to one embodiment, the control panel 40 is provided at the front of the tandem CD player 10.

The power button 42 allows the user to turn on and off the tandem CD player 10 by pressing the power button 42.

The transfer button 43 permits the user to switch from the first CD player 20 to the second CD player 30 and vice versa. The user is able to switch play between the two CD players 20,30 by pressing the transfer button 43. Consequently, should the user desire, he may interrupt the track being played and switch to the second track by pressing the transfer button 23. Once the tandem CD player 10 is turned on, a track is played by pressing the transfer button 43 and selectively programming either the first CD player 20 or the second CD player 30.

The mixer unit 80 receives a sound output from CD players 20,30 and modifies the sound output into an appropriate output signal 100 that is set by the control unit 70. The output signal 100 may be transmitted by cable 60 to a receiver, amplifier or the like.

The tandem CD player 10 may be provided with a remote control receiver unit 51 that allows the user to access the transfer feature from a remote location. Thus, the user is provided with a remote control that allows him to move to the next track by activating the remote control receiver unit 51.

The tandem CD player 10 is provided with a fader control unit 75 that allows the user to set a fading period that the mixer fades out the current track before the tandem CD player 10 starts playing the selected track from the other CD player. The fader control unit 75 is preferably part of the control unit 70. Once the time has been set in the fader control unit 75, the control unit 70 transmits this information to the CD players 20,30 and mixer.

The fader button 44 is connected to the fader control unit 75. The user sets the fading period by pressing the fader button 44. Every time the fader button 44 is pressed, the fading period is increased by one second. When the fader control unit 75 is set to zero, the next track will be played at the exact end of the previous track. The fader control unit 75 is automatically reset when the power to the tandem CD player 10 is turned off.

The control unit 70 appropriately adjusts the CD players 20,30, when the user makes any adjustments on the controls panel 40. For example, when the transfer button 43 or the fader button 44 are adjusted by the user, the two CD players 20,30 and mixer 80 are appropriately instructed by the control unit 70.

What is claimed is:

1. A tandem CD player for playing a selected track from two different CDs, said tandem CD player comprising:
a control unit;
a control panel, said control panel connected to said control unit, said controls panel having a plurality of controls for adjusting the operation of said control unit; and
a first CD player and a second CD player connected to said control unit, said first CD player and said second CD player capable of playing a first CD and a second CD respectively, said control unit controlling the operation of said first CD player and said second CD player, such that the second CD player is capable of playing a selected track from the second CD directly after a track from the first CD without interruption; and
a fader control unit for setting a fading period for the sound output from said first CD player and said second CD player, the fader control unit having a fader switch for allowing a user to adjust the fading period.

2. The tandem CD player of claim 1, wherein said controls panel comprises a transfer button, said transfer button allowing user to transfer the sound output between said first CD player and said second CD player.

3. The tandem CD player of claim 2, further comprising a remote control receiver unit for allowing a person to transfer the sound output between said first CD player and said second CD player from a remote location.

4. The tandem CD player of claim 3, wherein said first CD player and said second CD player comprise a CD drawer, a rewind button, a fast forward button and an open/close button.

5. The tandem CD player of claim 4, further comprising a mixer unit, said mixer receiving the sound from said first CD player and said second CD player, said mixer unit further connected to said control unit, said mixer unit outputting the sound received from said first CD player and said second CD player, said control unit controlling the output from said mixer unit.
